(19) United States
(12) Patent Application Publication
(10) Pub. No.: US 2008/0136598 A1
(43) Pub. Date: Jun. 12, 2008

(54) INTELLIGENCE CARRIER

(75) Inventors: Pei-Chun Chen, Yonghe City (TW); Yueh-Hsuan Lee, Hsinchu County (TW); Chia-I Lin, Kaohsiung City (TW); Chin-Ming Kuo, Hsinchu County (TW)

Correspondence Address: WPAT, PC, 7225 BEVERLY ST., ANNANDALE, VA, 22003, US

(73) Assignee: INDUSTRIAL TECHNOLOGY RESEARCH INSTITUTE, Hsin-Chu (TW)

(21) Appl. No.: 11/938,332

(22) Filed: Nov. 12, 2007

(30) Foreign Application Priority Data
Dec. 6, 2006 (TW) 095145275

(51) Int. Cl. H04Q 5/22

(52) U.S. Cl. 340/10.1; 340/572.8

(57) ABSTRACT

An intelligence carrier is disclosed, which is primarily comprised of at least a frame and at least a movable part. The frame is configured with at least a RFID reader and an antenna so that the movable part, being attached by a RFID tag, is able to communicate with the aforesaid RFID reader through the RFID tag, and then, as the RFID reader is able to communicate with a center control, the position of each movable part can be tracked in real time and the amount of the movable parts can be monitored.

### FIELD OF THE INVENTION

The present invention relates to an intelligence carrier, and more particularly, to an intelligence carrier having at least a radio frequency identification (RFID) reader arranged thereon.

### BACKGROUND OF THE INVENTION

Radio frequency identification (RFID) is an automatic identification technology with ability to wireless communication (read and write data without direct contact) and without the necessity for line-of-sight, such that it is convenient, easy to use and well suited for automatic operation and can function under a variety of environment conditions while providing a high level of data integrity. RFID is a technology with bright future and is going to replace the conventional bar coding system for many companies and organizations are trying now to implement RFID in their infrastructure. RFID systems exist in countless variants, produced by many different manufacturers, but RFID system is mainly consists of RFID tags, readers and a computer system. RFID tag is a device capable of storing data and transmitting data to reader which is located on the object to be identified. Both the RFID tag and the reader are equipped with antennas, by which when the RFID tag is interrogated by a reader, the data stored in the RFID tag will be transmitted from the antenna of the tag to the reader through the antenna thereof and then the received data is further being transmitted to the computer system through the antenna of the reader so that the RFID tag is tracked and managed.

Generally, when a conventional RFID system is being applied in a warehouse or a wholesale store, its computer system is usually being stationed at a specific location while attaching RFID tags on each items of the warehouse/wholesale store and arranging a plurality of readers in that warehouse/wholesale store at positions capable of enabling the interrogation zones of those readers to cover all the possible traveling paths of the tagged items. With such RFID system, any tagged item passing through an interrogation zone of one of the plural readers, its RFID tag will be detected by that reader and thus its location is tracked and acknowledged by the computer system automatically. However, there are a number of possible disadvantages related to the use of such conventional RFID system and these are summarized as follows:
(1) The plural readers are all fixedly stationed and are mostly being arranged at positions that are not easily accessible and difficult for the readers to mount thereat, so that the lack of mobility of such readers will often cost more manpower and material while requiring to remove a certain reader from or add an additional reader at a certain location, and thus such RFID system is not suitable for small/middle business.
(2) As the arrangement of each such reader must accompanies by a circuit layout including various components, such as antenna, power lines, cable lines, network wiring, and so on, not only it is difficult to have a tidy environment, but also the failure rate of the RFID system will be relatively high since those various components are mostly exposed to the environment.

In addition, take a garment retail store for instance, as there are garments of various styles and sizes that are displayed on hangers and display cabinets, they are required to be tracked and managed while being classified with respect to styles, sizes, genders and age groups that is not achievable by a conventional RFID system. Moreover, as the shopping behavior happening in a garment retail store is different from that in a common retail store that a consumer selects and remove a garment from its hanger is most likely going to try on the garment before having it billed, and in some case, will leave the selected garment at any location without returning it back to its original hanger if he/she decides that the garment is not of his/her preference, the exact amount of garments on any one hanger of the garment store is unknown that not only it is difficult to evaluate the inventory of the store, but also the poor inventory of the store will have adverse impact on consumers' willingness to pay and their purchase behavior that cause the sale of the garment to decrease since the clerks of the store is unable to maintain the garments of all styles and of all sizes at any time.

There are many researches addressing the aforesaid shortcomings. One such research is a hanger-based system disclosed in U.S. Pat. No. 7,059,518, entitled “RFID Device Detection System and Method”, which is a transmission line structure integrating conductors arranged respectively in a rod and a hanger. By arranging such conductors in rods and hangers, the detection range of the antenna of each reader used in the system can be prolonged and thus the interrogation efficiency is enhanced that facilitate the system to be used in garment management applications. However, the structure of readers used in the aforesaid RFID system is still the same as those conventional readers that the purpose of arranging an antenna in each reader is only to ensure and enlarge its interrogation field, and has no effect on helping to improve the two disadvantages mentioned above, not to mention that it is incapable of tracking and managing garments while classifying the same with respect to styles, sizes, genders and age groups.

Another such research is disclosed in TW Pat. No. 565802, which is a RFID system capable of using a signal generator to emit a RF signal to be received by a RFID tag attached on an object for enabling an indicator of the RFID tag to generate a response. One another such research is disclosed in TW Pat. No. 466458, which is a RFID system capable of marking and displaying information relating to the moving history of the object on a RFID tag attached to the object. Yet, another such research is related to a permanently attached identification device disclosed in U.S. Pat. No. 5,785,181, entitled “Permanent RFID Garment Tracking System”, which is a button sized RFID tag having a unique number. When the RFID tag is applied to a garment while visiting a dry cleaner the first time and the identification number is read, information related to the garment (such as owner name, dates, reason for cleaning, etc.) is input to a computer along with the identification number, and each time the garment is deposited with the dry cleaner the RFID tag is automatically read by a tag reader near the garment conveyor so that the computer maintains a history record related to the garment with reference to the identification number of the RFID tag attached thereto. However, all the aforesaid patents are only improving the location tracking/management ability of their RFID systems, and have no effect on helping to improve the two disadvantages mentioned above, not to mention that they are incapable of tracking and managing garments while classifying the same with respect to styles, sizes, genders and age groups.

Therefore, it is in need of a easy-to-install, low-cost intelligence carrier, that is not only capable of maintaining the safety and decoration of an ambient environment where it is disposed, but also capable of cooperating with an computer system for tracking and managing garments while classifying the same with respect to styles, sizes, genders and age groups as well as their whereabouts.

### SUMMARY OF THE INVENTION

It is the primary object of the present invention to provide an intelligence carrier, comprising:
at least a frame, each having at least a RFID reader and an antenna fitted thereon, and each used for supporting objects to be displayed; and
at least a mobile part, each having a RFID tag attached thereto;
wherein, each RFID tag is capable of transmitting data to the at least one RFID reader.

In a preferred embodiment of the invention, an intelligent carrier is comprised of a plurality of frames, including:
at least a master frame, each having at least a RFID reader and an antenna fitted thereon; and
at least an auxiliary frame, each having an antenna fitted thereon;
wherein, all the master and auxiliary frames are electrically connected to each other as each one of the master and auxiliary frames is configured with a connection port for receiving a connecting terminal, and thus, enabling all the master and auxiliary frames to be electrically connected with each other in a wired manner.

Preferably, each frame is comprised of:
a base;
at least a supporting part, each formed upward extendedly on the base; and
at least a handing part, each being arranged on the at least one supporting part, provided for the at least one mobile part to mount thereon.

Preferably, each handing part is a bar-like component, being supported by the at least one supporting part. In a preferred aspect, more than one such bar-like hanging parts are arranged in a manner selected form the group consisting of: the plural hanging parts are arranged parallel to each other; the plural hanging parts are arranged intersecting one another; the plural hanging parts are arranged radially with respect to an axis of one of the at least one supporting part; the plural hanging parts are arranged to form a ring-like structure encircling one of the at least one supporting part; and the combination thereof.

Preferably, the at least one handing part is made of a conductive material, for enabling the same to be used as the antenna for the at least one RFID reader of its corresponding frame as soon as the same is connect electrically to the at least one RFID reader.

Preferably, each supporting part is configured with a flat top, provided for the antennas of the at least one RFID reader to arranged thereon.

Preferably, each RFID reader is arranged on a bottom of its corresponding frame and the antenna of such RFID reader is arranged on a top of the corresponding frame, whereas the antenna and the RFID reader is electrically connected by a signal line.

Preferably, the at least one RFID reader and the antenna can be invisibly embedded into the components of a frame corresponding thereto.

Preferably, the RFID tag as well as the antenna can be attached to an object selected from the group consisting of the mobile part, an item hung on the mobile part, and a combined object of the aforesaid two.

Preferably, each frame is electrically connect to a computer system, being used for receiving and processing data acquired by the at least one RFID reader.

Other aspects and advantages of the present invention will become apparent from the following detailed description, taken in conjunction with the accompanying drawings, illustrating by way of example the principles of the present invention.

### BRIEF DESCRIPTION OF THE DRAWINGS

FIG. 1 is a schematic diagram depicting an intelligence carrier according to a preferred embodiment of the invention.

FIG. 2 shows a master frame being connected to an auxiliary frame by a wire according to a preferred embodiment of the invention.

FIG. 3 is a schematic diagram showing an intelligence carrier being configured with a plurality of electrical-connected frames, whereas the plural frames are arranged closely adjacent to one another.

FIG. 4 shows a frame being connected to another frame in a wireless manner according to a preferred embodiment of the invention.

FIG. 5 is a schematic diagram showing an intelligence carrier being configured with a plurality of frames, whereas the plural frames are electrically connected to one another by a wireless manner.

FIG. 6 is a schematic diagram depicting an intelligence carrier according to another preferred embodiment of the invention.

FIG. 7 to FIG. 9 are schematic diagrams showing three different intelligent carriers of the invention.

### DESCRIPTION OF THE PREFERRED EMBODIMENT

For your esteemed members of reviewing committee to further understand and recognize the fulfilled functions and structural characteristics of the invention, several preferable embodiments cooperating with detailed description are presented as the follows.

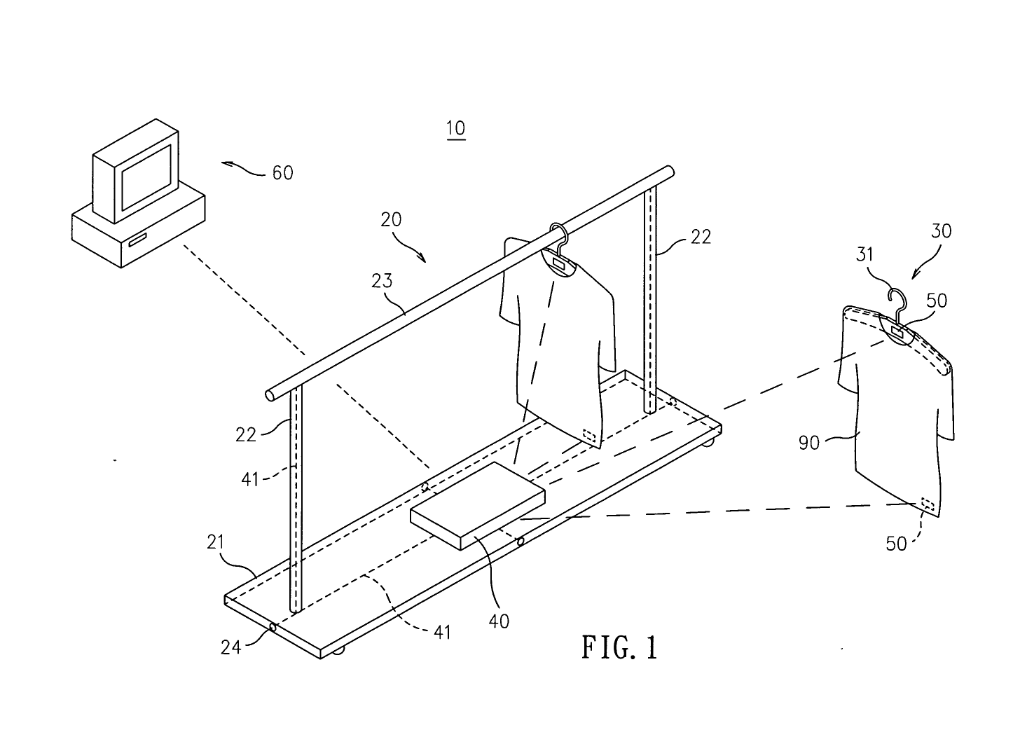

Please refer to FIG. 1, which is a schematic diagram depicting an intelligence carrier according to a preferred embodiment of the invention. The intelligence carrier 10 is primarily composed of at least a frame 20 and at least a mobile part 30, in which the frame 20 is further comprised of: a base 21; and a plurality of bar-like supporting parts 22, ach being formed upward extendedly on the base 21; and at least a bar-like handing part 23, each being arranged on and supported by the plural supporting parts. In this preferred embodiment, the base 21 is a rectangle-shaped flat panel; and there are two supporting parts 22 being arranged on a top surface of the base 21 parallelly at positions symmetrical to each other with respect to an center of the base 21, whereas there is one bar-like handing part 23 being supported by and mounted on the tops of the two supporting parts 22. Moreover, in this preferred embodiment, the mobile part 30 is a hanger having a hook 31 formed thereat, which is provided for a garment 90 to hang thereon and capable of grasping the hanging part 23 by the hook 31 thereof. As seen in FIG. 1, the garment 90, hung on the mobile part 30 whereas the mobile part is hooked on the hanging part 23, is being displayed by handing the same on the frame 20. It is noted that the aforesaid carrier structure is only an illustration of the present invention which is not limited thereby. That is, any structure that is so-structured for enabling a mobile part thereof to be detachable from the frame thereof can be implemented as an embodiment of the invention. For instance, the frame 20 can be a suspending hanger bar or a wall-mounted cabinet, etc.; the mobile part 30 can be a hook, a connecting wire, even can be any object that is to be displayed itself, such as garments, shoes, belts, gloves, hats, scarf, and so on, whichever capable of being arranged directly on the frame 20.

As seen in FIG. 1, the frame 20 is configured with a RFID reader 40 and the mobile part 30 is attached by a RFID tag 50, that both the RFID reader 40 and the RFID tag 50 are respectively equipped with an antenna. In a preferred aspect, the antenna of the RFID reader 40 can be embedded inside the hanging part 23 while being electrically connected to the RFID reader 40 by a signal line 41 extending therefrom; or by making the handing part 23 of a conductive material, the hanging part 23 can be used as the antenna of the RFID reader 40 directly as soon as the same is connect electrically to the RFID reader 40 by the signal line 41. The power of the RFID reader 40 is provided by a power supply, such as an external power source, a battery, or a rechargeable battery, etc. Moreover, a power line connecting the RFID reader 40 to the power source, or even the power source itself can be invisibly embedded into the components of the frame 20 under the condition that there is enough space designed in the frame 20 for accommodating the power line and power source. It is even possible to conceal the RFID reader 40 inside the frame 20 if there is enough space. As for the antenna of the RFID tag 50, it is a thin device integrally-formed with the RFID tag 50 that is known to those skilled in the art and thus is not described further herein. However, it is emphasized that the RFID tag 50 used in the present invention can be either attached to the mobile part 30 or the garment 90, or in some circumstance, both the mobile part 30 and the garment 90 are attached by RFID tag 50s in respective.

As soon as the RFID tag 50 is interrogated by the RFID reader 40, data of the RFID tag 50 is detected by the RFID reader 40 and send to a computer system 60 where the data is processed so as to perform a location-tracking/inventory operation upon the object hung on the mobile part 30 with the RFID tag 50, i.e. the garment 90. In a preferred aspect, the RFID tag 50 can be encoded with different identification code with respect to the different characteristics of the object hung on the mobile part 30, such as the styles and the sizes of the garment 90, and thus there should be different RFID readers 40 specifically configured to match with different RFID tags according to the different identification codes encoded therein. In addition, the computer system 60 can be connected electrically to the RFID reader 40, i.e. to the frame 20, by a wired or wireless means, that is, the data detected by the RFID reader 40 can be transmitted to the computer system 60 in a wired or a wireless manner.

To be more specific, by hanging garments 90 respectively on a hanger-like mobile part 30 and then hooking all the hangers 30 along with the garments on the hanging bar 23 of the frame 20, the garments 90 are inventoried by the computer system as soon as the RFID tags 50 of the hangers 30 or garments are interrogated by the RFID reader 40. Thus, when a consumer selects and remove a garment 90 along with its hanger 30 from the frame 20 for trying on and then leaves the selected garment at any location, such as in a fitting room or hanging on other frame, without returning it back to its original frame 20 if he/she decides that the garment is not of his/her preference, or even steals the selected garment 90 and bring it out of the garment store, the exact location of selected garment 90/the mobile part 30 can be tracked in real time by the detection of the RFID readers and thus a clerk of the store is able to find the garment 90 rapidly and accurately. It is noted that the interrogation filed of each RFID reader 40 can be defined with respect to the size of the sales space or wholesale store where the RFID readers are to be disposed. Moreover, as the computer system 60 is integrated with a billing and an inventory system, the exact inventory and sales amount of a selected garment 90 can be acquired as soon as the billing process of the selected garment 90 is accomplished.

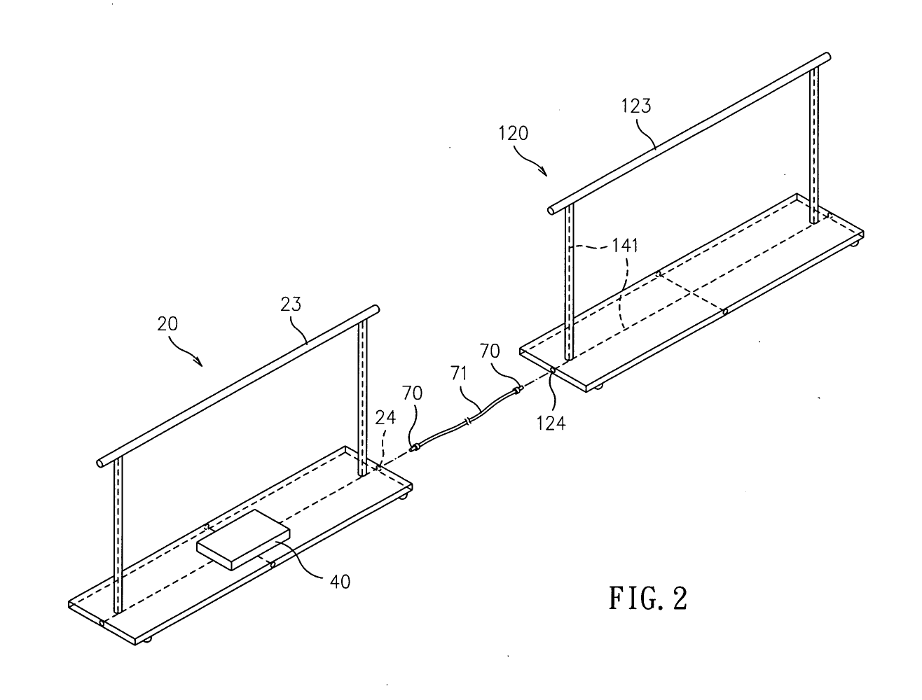

The size of the frame 20 is adjustable with respect to any actual requirement, such as the size of the object to be displayed thereon, and the space where the frame is to be disposed, and so on. For increasing the mobility of the frame 20 as well as increasing the flexibility of adjusting the frame size, a plurality of connection ports 24 is configured at the base 21 of the frame 20, as those seen in FIG. 1, that each connection port 24 is electrically connected to the RFID reader 40 by the signal line 41. Please refer to FIG. 2, which shows a master frame being connected to an auxiliary frame by a wire according to a preferred embodiment of the invention. The master frame of FIG. 2 is substantially the frame 20 of FIG. 1, which is comprised of the RFID reader 40, and the auxiliary frame 120 of FIG. 2 is simply another frame 20 of FIG. 1 without the RFID reader 40. As seen in FIG. 2, by plugging two connecting terminals 70 of a cable 71 with a specific length respectively into the connection port 24 of the master frame 20 and the connection port 124 of the auxiliary frame 120, the master frame 20 and auxiliary frame 120 are electrically connected with each other in a wired manner. In addition, as the connection port 124 of the auxiliary frame 120 is connected to the antenna embedded in its handing part 123 by a signal line 141, the interrogation field of the RFID reader 40 can be extended by the antenna of the auxiliary frame 120 as soon as the master frame 20 is serially connected to the auxiliary frame 120, and thus the overall amount of RFID readers 40 required to be installed in a space of a specific size can be reduced and the cost is reduced as well.

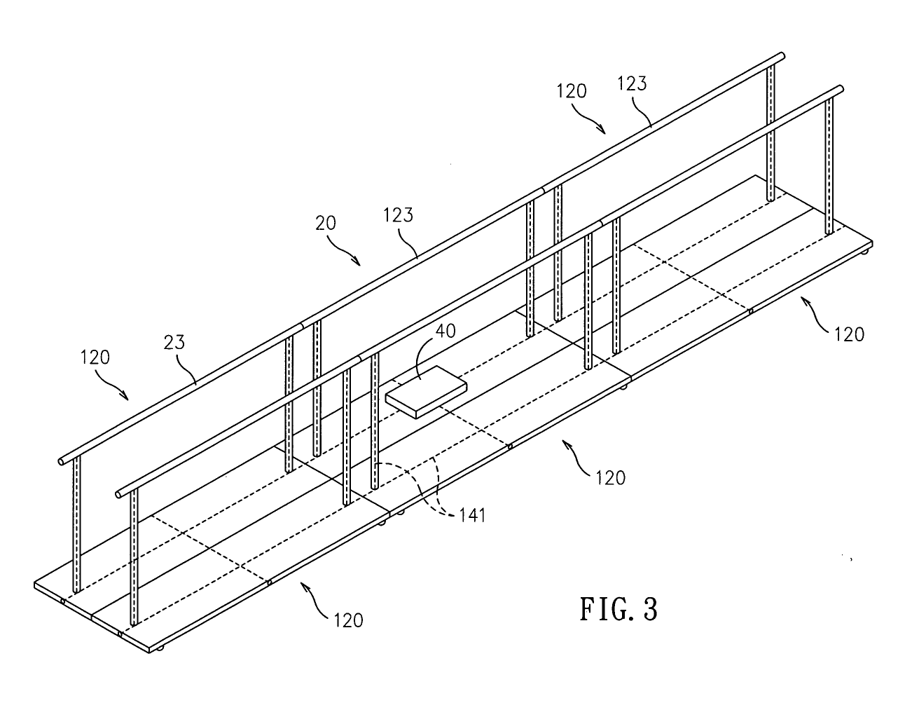

Please refer to FIG. 3, which is a schematic diagram showing an intelligence carrier being configured with a plurality of electrical-connected frames, whereas the plural frames are arranged closely adjacent to one another. The embodiment shown in FIG. 3 is an extension of that shown in FIG. 2, in which the intelligence carrier is configured with a master frame 20 and five auxiliary frames 120, whereas those frames are either serially connected or parallelly connected while being arranged closely adjacent to one another. Other then that shown in FIG. 2, the cable 71 with two connecting terminals 70 is replaced by an adapter capable of being plugging into two connection ports of two neighboring frames for enabling the two frame to be tightly connected. In addition, if there are more than one master frames 20 being configured in the intelligence carrier, the interrogation filed of the RFID reader 40 of each master frame 20 can be adjusted independently so that different RFID reader 40 can be enabled to cover different area. Moreover, the plural master frames 20 are capable of being activated in a manner selected from the group consisting of: activating only one of the plural master frames; activating a portion of the plural master frames, activating all of the plural master frames. It is noted that the aforesaid interrogation field adjustment as well as the activation selection are controlled by the computer system shown in FIG. 1.

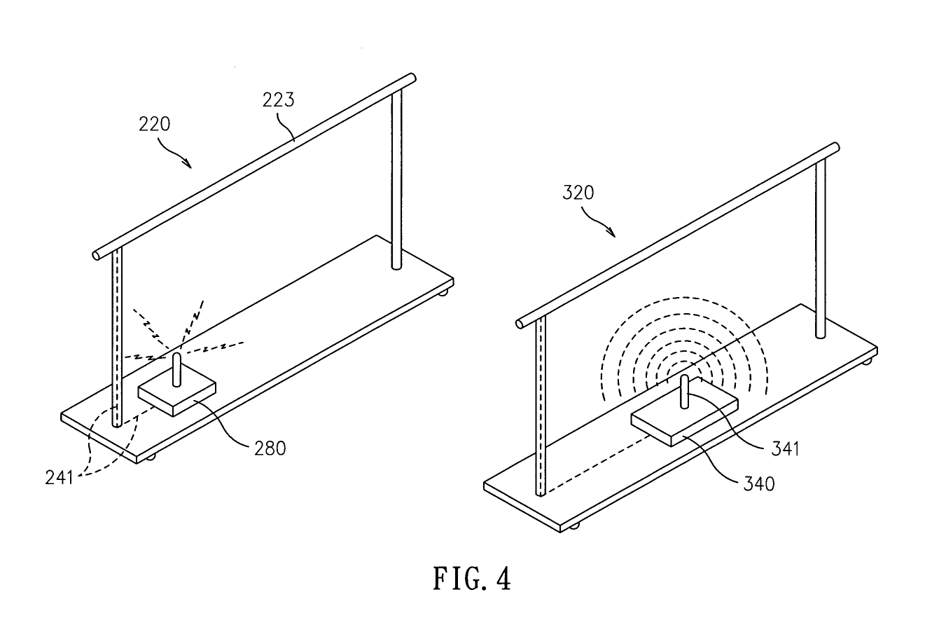

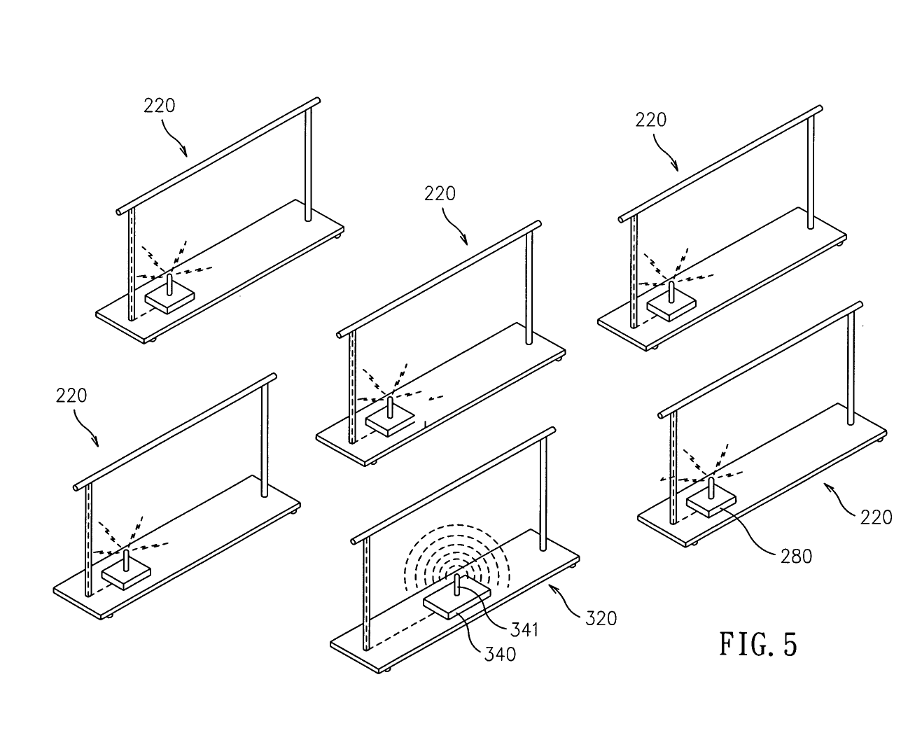

In stead of connecting the plural frames in the wired manner, as those shown in FIG. 2 and FIG. 3, the electrical-connection of the plural frames can be achieved by a wireless manner, as that shown in FIG. 4. In FIG. 4, the auxiliary frame 220 is configured with a wireless controller 280, connected to the antenna embedded in the hanging part 223 by a signal line 241, by which signals of the wireless controller 280 can be send to the master frame 320 in a wireless manner where it is received by the RFID reader 341 and further being transmitted to the computer system. As seen in FIG. 5, the five auxiliary frames 220, each being fitted with a wireless controller 280, are electrically connected to a master frame 320 with RFID reader 340 in a wireless manner. As the electrical-connection of FIG. 5 are enabled by a wireless means, no cable is required that not only it is freed from the trouble of cable layout and thus the surrounding tidiness is improved, but also the hazard of being tripped by cables can be avoid. In addition, the distance between any auxiliary frame 220 and the master frame 320 can be adjusted at will with respect to user's preference, only if the distance is not exceed the transmission range of the wireless controller 280 and the receiver 341 of the RFID reader 340.

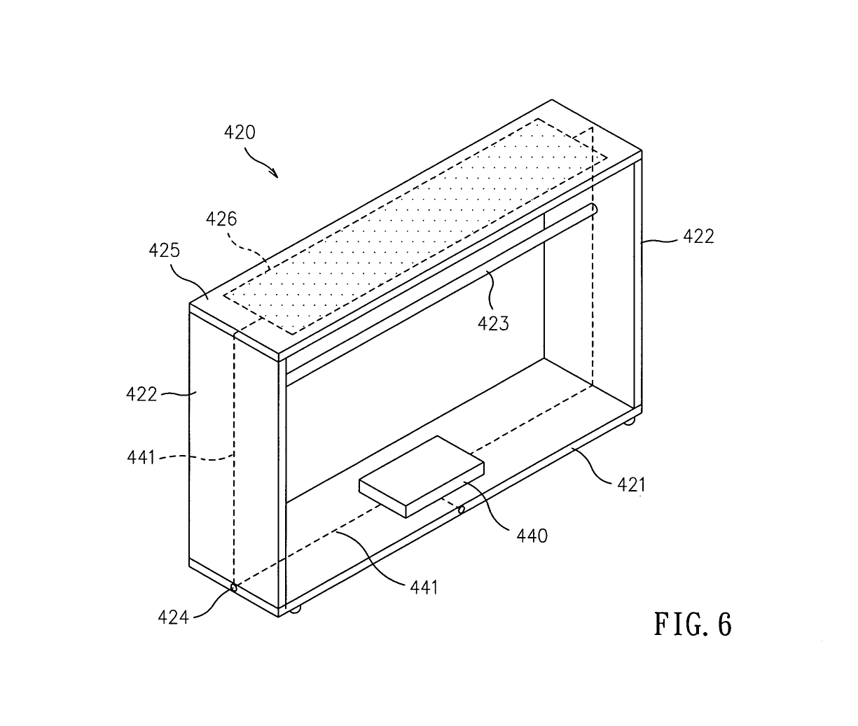

Please refer to FIG. 6, which is a schematic diagram depicting an intelligence carrier according to another preferred embodiment of the invention. The frame 420 is a rectangle structure, comprising: a bottom pane 4211, used as the base of FIG. 1; two side panels 422, used as the two supporting part of FIG. 1; a top panel 425, having an antenna 426 fitted therein; and a hanging part 423, being received in the space enclosed by the rectangle structure at a position right under the top panel 425; wherein, a RFID reader 440 is arranged on the bottom panel 421 which is further electrically connected to the antenna 426 by a signal line 441. Similar to the frame 20 of FIG. 1, the bottom panel 421 is further configured with a plurality of connection ports, each being provided for connecting electrically with another frame. It is noted that the functions of all the components structured in the frame 420 of FIG. 6 are the same as those shown in FIG. 1 and thus are not described further herein.

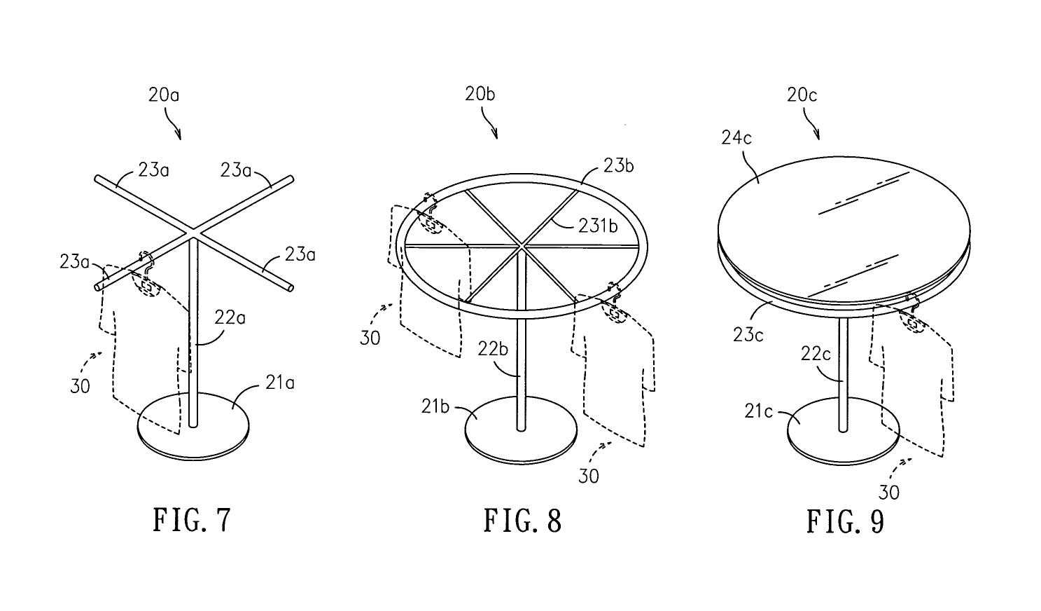

Please refer to 7 to FIG. 9, which are schematic diagrams showing three different intelligent carriers of the invention. In FIG. 7, the frame 20a is comprised of a plurality of hanging parts 23a, being arranged intersecting to each other as the cross-shaped structure seen in FIG. 7, whereas the cross-shaped structure is supported by a bar-like supporting part 22a, which is arranged upward extendedly on a base 21a. In FIG. 8, the frame 20b has a base 21b and a supporting part 22b that are the same as those shown in FIG. 7. However, the hanging part 23b thereof is a ring-like structure that is supported by a strut structure 231b, provided for mounting the ring-like structure on the supporting part 22b while enabling the signal line to extend from the supporting part 22b to the hanging part 23b. In FIG. 9, the frame 20c is structured similar to that shown in FIG. 8, that it has a ring-like hanging part 23c, being supported by a bar-like supporting part 22c which is arranged upward extendedly on a base 21c. The difference between the frame 20c and the frame 20a is that: a additional circular panel 24c is mounted on top of the ring-like hanging part 23c, which is provided for an antenna to embed therein as well as capable of being used for bearing products thereon. It is noted that all the aforesaid hanging parts 23a, 23b, 23c are capable of operating as an antenna and being provided for the mobile parts 30 to hook thereon. Moreover, all the embodiments shown in FIG. 7˜FIG. 9 are equipped with signal lines and connection ports similar to those shown in FIG. 1˜FIG. 3, and thus are not described further herein.

To sum up, the intelligence carrier, being an assembly of master frames and auxiliary frame, is a structure that not only can be easily assembled and constructed at a comparatively low cost, but also can be established without requiring to plan a field study for organizing the setup of those RFID readers, cables and antennas. In addition, as the intelligence carrier is able to work cooperatively with a computer system, it is capable of tracking and managing goods while classifying the same with respect to styles, sizes, genders and age groups. Since the intelligence carrier of the invention is a low-cost device, it is suitable to be used in garment retail store or wholesale store that enabled clerks of such store to aware of the exact inventory of garments current being displayed and stored in the store in real time, and also enable clerks to acquire information from the RFID tag attached on the garments of the store so as to evaluate whether a garment is still situated at its original location or to track the current location of a miss-placed garment, thereby, the store can be organized with high efficiency.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. An intelligence carrier, comprising:
at least a frame, each having at least a RFID reader and an antenna fitted thereon, and each used for supporting objects to be displayed; and
at least a mobile part, each having a RFID tag attached thereto;
wherein, each RFID tag is capable of transmitting data to the at least one RFID reader.

2. The intelligence carrier of claim 1, being comprised of a plurality of frames, including:
at least a master frame, each having at least a RFID reader and an antenna fitted thereon; and
at least an auxiliary frame, each having an antenna fitted thereon;
wherein, all the master and auxiliary frames are electrically connected to each other.

3. The intelligence carrier of claim 2, each one of the master and auxiliary frames is configured with at least a connection port, each for receiving a connecting terminal, and thus, enabling all the master and auxiliary frames to be electrically connected with each other in a wired manner.

4. The intelligence carrier of claim 3, wherein a cable of a specific length is arranged between any two of the connecting terminals for connecting the two.

5. The intelligence carrier of claim 2, wherein each one of the master and auxiliary frames is configured with a wireless communication device for enabling all the master and auxiliary frames to be electrically connected with each other in a wireless manner

6. The intelligence carrier of claim 5, wherein the wireless communication device configured in each master frame is a wireless controller, being used for achieve an electrical connection in a wireless manner.

7. The intelligence carrier of claim 2, wherein there are more than one master frames being comprised in the intelligence carrier while enabling the interrogation filed of each RFID reader arranged in the plural master frames to be adjustable.

8. The intelligence carrier of claim 7, wherein the plural master frames are capable of being activated in a manner selected from the group consisting of: activating only one of the plural master frames; activating a portion of the plural master frames, activating all of the plural master frames.

9. The intelligence carrier of claim 2, wherein each frame is comprised of:
a base;
at least a supporting part, each being formed upward extendedly on the base; and
at least a handing part, each being arranged on the at least one supporting part, provided for the at least one mobile part to mount thereon.

10. The intelligence carrier of claim 9, wherein each handing part is a bar-like component, being supported by the at least one supporting part, and when there are more than one such bar-like hanging parts being arranged in a frame, they are arranged in a manner selected form the group consisting of: the plural hanging parts are arranged parallel to each other; the plural hanging parts are arranged intersecting one another; the plural hanging parts are arranged radially with respect to an axis of one of the at least one supporting part; the plural hanging parts are arranged to form a ring-like structure encircling one of the at least one supporting part; and the combination thereof.

11. The intelligence carrier of claim 10, wherein the at least one handing part is made of a conductive material, for enabling the same to be used as the antenna for the at least one RFID reader of its corresponding frame as soon as the same is connect electrically to the at least one RFID reader.

12. The intelligence carrier of claim 9, wherein each supporting part is configured with a flat top, provided for the antennas of the at least one RFID reader to arranged thereon.

13. The intelligence carrier of claim 1, wherein each RFID reader is arranged on a bottom of its corresponding frame and the antenna of such RFID reader is arranged on a top of the corresponding frame, whereas the antenna and the RFID reader is electrically connected by a signal line.

14. The intelligence carrier of claim 1, wherein the at least one RFID reader and the antenna can be invisibly embedded into the components of a frame corresponding thereto.

15. The intelligence carrier of claim 1, further comprising:
a power line, capable of being received inside the frame for inputting power therefrom.

16. The intelligence carrier of claim 1, wherein the at least one movable part is so constructed that it can be hung on the at least one frame so as to be used for hanging objects to be displayed, such as clothes, shoes, accessories and ornaments.

17. The intelligence carrier of claim 16, wherein the RFID tag as well as the antenna can be attached to an object selected from the group consisting of the mobile part, an item hung on the mobile part, and an combined object of the aforesaid two.

18. The intelligence carrier of claim 1, wherein each frame is electrically connect to a computer system, being used for receiving and processing data acquired by the at least one RFID reader.

19. The intelligence carrier of claim 18, wherein the electrical-connection between the computer system and each frame is enabled by a manner selected from the group consisting of: a wired manner and a wireless manner.

20. The intelligence carrier of claim 18, wherein the data transmission between the computer system and each RFID reader is proceeded by a manner selected from the group consisting of: a wired manner and a wireless manner.

21. The intelligence carrier of claim 1, wherein the at least one mobile part can be detached from the at least one frame.
